(19) United States
(12) Patent Application Publication
(10) Pub. No.: US 2006/0294537 A1
(43) Pub. Date: Dec. 28, 2006

(54) Fingerprint-based technique for surveying an audience

(76) Inventor: Lee S. Weinblatt, Teaneck, NJ (US)

Correspondence Address: COHEN, PONTANI, LIEBERMAN & PAVANE;Suite 1210, 551 Fifth Avenue, New York, NY, 10176, US

(21) Appl. No.: 11/158,858

(22) Filed: Jun. 22, 2005

(51) Int. Cl. H04N 7/16; H04H 9/00

(52) U.S. Cl. 725/10; 725/9

(57) ABSTRACT

A fingerprint reading mechanism is utilized so as to determine which audience members are present during various stages of an audio, visual, or audiovisual program. The fingerprint reading mechanism is associated with a processing mechanism, an “enter” button, an “exit” button, a clock, memory, an output indicator, and a code receiver. As an audience member enters or exits the program performance area, the audience member places a hand, or portion thereof, in proximity to the fingerprint reading mechanism, and also presses the “enter” or “exit” button as appropriate. Optionally, the functionalities of the “enter” button and the fingerprint reading mechanism may be combined into a single automatically activated enter/fingerprint reading mechanism, and the functionalities of the “exit” button and the fingerprint reading mechanism may be combined into a single automatically activated exit/fingerprint reading mechanism. The fingerprint reading mechanism generates a fingerprint data record in response to a human hand, or portion thereof, held in proximity thereto. The processing mechanism compares the generated fingerprint data record with each of a plurality of stored fingerprint data records accessed from memory so as to permit retrieval of an audience member identifier corresponding to the generated fingerprint data record. An audience log entry associates the retrieved audience member identifier with a corresponding clock time parameter and a corresponding enter/exit parameter. In response to retrieving an audience member identifier from a generated set of fingerprint data, the processing mechanism creates and stores an audience log entry by loading the current value of the clock as the clock time parameter.

### FIELD OF THE INVENTION

This invention is directed to surveying techniques applied while an audience is listening to and/or viewing a program performed by reproduction equipment and, more particularly, to techniques that identify individual members of that audience.

### BACKGROUND OF THE INVENTION

When a program is broadcast, it is oftentimes desirable to obtain information about the audience. The “program”, obtained as a programming signal from a program signal source, can be audio and/or video, commercial and/or non-commercial. Broadcast of the program may take place over the airwaves, cable, satellite, Internet, telephone lines, or any other signal transmission medium. The term “broadcast” also encompasses playback from storage media such as audio tape, video tape, DAT, DVD, CD-ROM, and semiconductor memory. An “audience” for such program reproduction is constituted of the persons who perceive the program. Thus, all the people who have perceived any part of the program are included in the audience, but those present so as to perceive the program at a given time are considered as forming the audience in attendance.

The program is “performed” by any means which result in some form of perception by human beings, the most common being video and audio. The “reproduction equipment” is any and all types of units which convert a signal into a humanly perceptible form.

The audience is typically described as being “tuned” to a program when the signal source is a TV or radio broadcast station. This term may be less commonly applied when the signal source is a tape recorder. However, for the sake of brevity and convenience, the word “tuned” is applied herein to all situations in which an audience member selects a particular program, whether it be by twisting a dial, operating a remote control, or popping a cassette into a tape recorder for playback.

In the past, audience survey information has been gathered by audience measurement and market research organizations which provide such information for the benefit of advertisers and broadcasters. For example, advertisers are interested in knowing the number of people exposed to their commercials. Also, broadcasters use statistics on audience size and type for setting their advertising rates.

It is of interest to survey an audience not only in terms of its overall size, but also to obtain various demographic characteristics of its individual members. Thus, for example, advertisers may wish to identify audience members in terms of economic and social categories. This is possible if individual members of the audience can be identified.

Prior art techniques for obtaining audience information utilize one of the following approaches. Pursuant to a first approach, households within a geographically defined market area wherein a plurality of television or radio stations can be received (either over the air or by cable) are contacted by phone and interviewed regarding their viewing or listening habits. Each person is questioned about the programs which that individual watched and/or listened to during the previous, say, twenty-four hours. However, this technique is suspect because it is subject to recall errors as well as possible bias introduced by the interviewer. For example, if a specific TV program is mentioned to the person being interviewed, the suggestion may elicit a positive response to a question regarding whether that program was watched even when it actually was not.

A second prior art approach requires test participants to keep broadcast diaries. Diary entries are made manually throughout the day to keep track of which television stations are viewed, or to which radio stations a participant is tuned. Diaries are then collected and analyzed. However, this approach is vulnerable to inaccuracies because the test subjects may fail to make entries due to forgetfulness, laziness, or a very busy schedule. Incorrect information may be entered if the test subject fills out the daily diaries days or weeks after a broadcast is aired. Thus, it can be readily seen that the phone-contact, recall-dependent approach described above is unsatisfactory because people may not accurately remember what they listened to at any particular time and, also, because of the potential problem of suggestive bias. The diary-based approach is likewise unsatisfactory because people may not cooperate and be as meticulous in making timely diary entries as required to obtain the desired record-keeping accuracy. The above-described approaches require a significant and time-consuming effort on the part of the test participants to respond to phoned-in questions, or to record their TV viewing and/or radio listening habits.

Partly automated systems have also been developed which require relatively less active audience member participation. U.S. Pat. No. 3,056,135, issued to Currey et al., describes automatically determining the listening habits of wave signal receiver users. The Currey device provides a record of the number and types of persons using a wave signal receiver by monitoring the operational conditions of the receiver and utilizing strategically placed switches for counting the number of persons entering, leaving, and remaining within a particular area. This device also employs a photographic recorder for periodically recording the composition of the audience. The photographic recorder thereby generates a mailable audience record in the form of a series of photographs that include information related to audience composition and receiver operation for subsequent manual processing by a survey organization. One shortcoming of this approach is a lengthy data acquisition process. Moreover, audience members may not wish to appear in a photographic record.

U.S. Pat. No. 4,644,509 issued to Kiewit et al. discloses an ultrasonic, pulse-echo method and apparatus for determining the number of persons in the audience and the composition of the audience for a radio and/or television receiver. First and second reflected ultrasonic wave maps of the monitored area are collected, such that the first map is prepared without people present, and the second map is prepared with people who may be present in the monitored area. The first collected background defining map is subtracted from the second collected map to obtain a resulting map. The resulting map is processed to identify clusters having a minimum intensity. A cluster size of the thus identified clusters is utilized to identify clusters corresponding to people in an audience. While this arrangement is effective for counting the overall number of members in the viewing audience, individual audience members cannot be identified.

In the context of many audience surveys, such as surveys conducted at the homes of participant volunteers, audience members are free to come and go as they please. It is oftentimes desirable or necessary to determine which audience members were actually present in the program performance area during various stages of an audio, visual, or audiovisual program. A system for identifying the presence of TV viewers in a room where the viewer wears a headphone which transmits an acknowledgment signal in response to periodic polls is described U.S. Pat. No. 4,632,915 issued to Heller, III.

Other audience presence detection techniques utilize a surveying code transmitted by a broadcast station in combination with a programming signal. As disclosed in U.S. Pat. No. 4,718,106, issued to the present inventor, the transmitted surveying code is detected by a receiver and reproduced by a speaker. The speaker produces pressure waves in the air that can be detected by a microphone, for example, and at a frequency that is scientifically regarded as being within the audible range of human hearing. Such pressure waves, or signals, are referred to as acoustical signals. An acoustical signal is regarded as being audible, irrespective of whether it is actually heard by a person, as long as it can be reproduced by a conventional speaker and detected by a conventional microphone. The audible acoustical signal is detected by a microphone and associated circuitry embodied in a portable device worn by the test participants. Data on the incidence of occurrence and/or the time of occurrence of the acoustical signal, and the code it contains, are stored and analyzed therein. Variations of this audience detection technique can be found in U.S. Pat. No. 5,457,807, as well as U.S. Pat. No. 5,630,203, both of which are issued to the present inventor. For example, each portable device may be pre-programmed with the unique identification (“ID”) of its wearer. This ID information is downloaded to a central processing station, with the detected codes stored in the portable device to provide not only audience measurement data but also information about individual audience members.

Although the use of portable devices to track audience member presence has great potential, this approach exhibits several shortcomings when implemented with the latest integrated circuit technology. For example, the cost per unit is unacceptably high. Also, the portable devices are too heavy to be worn comfortably. Furthermore, such devices require high memory capacity to store all of the data needed to provide desired survey information. Lastly, battery life is inconveniently shortened by all of the functions such a device would need to perform. Accordingly, until improved technology exists to implement such devices without these shortcomings, other approaches must be formulated.

U.S. patent application Ser. No. 09/519,248 discloses an effective approach for identifying audience members and gathering demographic information about broadcast-program-viewing behavior. A stationary device includes a transmitter which periodically sends out a query signal. The stationary device, positioned at a reception location with reproduction equipment for performing a program, is equipped to receive a surveying code signal which identifies a commercial as it is being broadcast. A plurality of portable devices are worn or carried by members of the audience. The portable devices each include a detector for detecting the query signal and, in response thereto, emitting an audience member identification signal. Each device worn or carried by an audience member generates a unique identification signal assigned to a specific individual. The stationary device includes a detector for detecting one or more identification signals. The portable devices may be provided in the form of a fob, watch, necklace, wristband, belt, or other wearable article. Using detected identification signals and surveying code signals, the stationary device is equipped to determine precisely which audience members are present during the broadcast of a commercial.

There are certain conditions under which the wearing of such portable devices is not desirable. A key point to keep in mind is that survey participants must be minimally inconvenienced so as to achieve full cooperation in the derivation of audience data that are accurate, reliable and complete. For example, if the portable device is too heavy, audience members may choose not to wear it. Some audience members may deliberately or unknowingly exchange their portable device with that of another audience member, causing identities to be switched, and compromising the overall accuracy of the audience survey. If device memory is often filled and must be frequently downloaded to enable the device to be used for storing current data, the download operation may be delayed to a later, more convenient time, thus eliminating some of the data that was gathered subsequent to the previous download. In view of the foregoing considerations, a sufficiently high level of audience compliance may not be achieved.

### SUMMARY OF THE INVENTION

One object of the present invention is to identify individual members of an audience.

Another object of the present invention is to determine which audience members are actually present in a program performance area during various stages of an audio, visual, or audiovisual program.

A further object of the present invention is to increase the reliability and accuracy with which survey information involving audience members is obtained.

A further object of the present invention is to facilitate the collection of audience surveying information by gaining the cooperation of the test subjects and by improving the speed with which the results are made available.

Yet another object of the present invention is to collect audience surveying information, including information about the audience members, at reasonable cost.

Yet another object of the invention is to collect audience surveying information without requiring audience members to wear or carry portable devices.

These and other objects are attained in accordance with one aspect of the present invention directed to an apparatus for determining which of one or more audience members are present in a program performance area equipped with reproduction equipment while it is reproducing an audio, visual, or audiovisual program, the apparatus comprising: (a) a fingerprint reading mechanism equipped to generate a fingerprint data record in response to a human hand, or portion thereof, held in proximity thereto; (b) a memory device equipped to store one or more fingerprint data records, wherein each of respective fingerprint data records is associated with a corresponding audience member identifier for identifying an audience member; (c) an input mechanism equipped to accept input from an audience member associated with at least one of the audience member entering the program performance area and the audience member exiting the program performance area; (d) a clock for providing a computer-readable clock output indicative of at least one of present time and elapsed time; and (e) a processing mechanism programmed to: (i) receive a fingerprint data record from the fingerprint reading mechanism, (ii) compare the received fingerprint data record with one or more stored fingerprint data records stored in the memory device to permit identification of a stored fingerprint data record that substantially matches the received fingerprint data record, (iii) retrieve the audience member identifier corresponding to the substantially matching stored fingerprint record from the memory device, (iv) detect activation of the input mechanism upon at least one of the audience member entering the program performance area and the audience member exiting the program performance area; (v) receive the clock output, and (vi) generate an audience log entry by associating each of respective activations of the input mechanism with the retrieved audience member identifier, an enter/exit parameter specifying either “enter” or “exit”, and a corresponding clock output.

Another aspect of the present invention is directed to an apparatus for determining which of one or more audience members are present in a program performance area equipped with reproduction equipment while it is reproducing an audio, visual, or audiovisual program, the apparatus comprising: (a) a first self-activating fingerprint reading mechanism equipped to generate a fingerprint data record in response to a human hand, or portion thereof, held in proximity thereto; wherein activation of the first self-activating fingerprint reading mechanism is associated with an audience member entering the program performance area; (b) a second self-activating fingerprint reading mechanism equipped to generate a fingerprint data record in response to a human hand, or portion thereof, held in proximity thereto; wherein activation of the second self-activating fingerprint reading mechanism is associated with an audience member exiting the program performance area; (c) a memory device equipped to store one or more fingerprint data records, wherein each of respective fingerprint data records is associated with a corresponding audience member identifier for identifying an audience member; (d) a clock for providing a computer-readable clock output indicative of at least one of present time and elapsed time; and (e) a processing mechanism programmed to: (i) detect activation of the first self-activating fingerprint reading mechanism upon the audience member entering the program performance area; (ii) detect activation of the second self-activating fingerprint reading mechanism upon the audience member exiting the program performance area; (iii) receive a fingerprint data record from at least one of the first self-activating fingerprint reading mechanism or the second self-activating fingerprint reading mechanism, (iv) compare the received fingerprint data record with one or more stored fingerprint data records stored in the memory device to permit identification of a matching stored fingerprint data record that substantially matches the received fingerprint data record, (v) retrieve the audience member identifier corresponding to the substantially matching stored fingerprint record from the memory device, (vi) receive the clock output, (vii) generate a first audience log entry by associating each of respective activations of the first self-activating fingerprint reading mechanism with the retrieved audience member identifier, an enter/exit parameter specifying “enter”, and a corresponding clock output; and (viii) generate a second audience log entry by associating each of respective activations of the second self-activating fingerprint reading mechanism with the retrieved audience member identifier, an enter/exit parameter specifying “exit” and a corresponding clock output.

Another aspect of the present invention is directed to an apparatus for determining which of one or more audience members are present in a program performance area equipped with reproduction equipment while it is reproducing an audio, visual, or audiovisual program, the apparatus comprising: (a) a fingerprint reading mechanism equipped to generate a fingerprint data record in response to a human hand, or portion thereof, held in proximity thereto; (b) a memory device equipped to store one or more fingerprint data records, wherein each of respective fingerprint data records is associated with a corresponding audience member identifier for identifying an audience member; (c) an “enter/exit” button; (d) a clock for providing a computer-readable clock output indicative of at least one of present time, real time, and elapsed time; and (e) a processing mechanism programmed to: (i) receive a fingerprint data record from the fingerprint reading mechanism, (ii) compare the received fingerprint data record with one or more stored fingerprint data records stored in the memory device to permit identification of a matching stored fingerprint data record that substantially matches the received fingerprint data record, (iii) retrieve the audience member identifier corresponding to the substantially matching stored fingerprint record from the memory device, (iv) detect a pressing of the “enter/exit” button, (v) receive the clock output, (vi) associate each of respective presses of the “enter/exit” button with a new log entry including the retrieved audience member identifier, an enter/exit parameter, and a corresponding clock output, by performing a search of previous log entries created during a predetermined time interval to identify a total number of previous log entries corresponding to the retrieved audience member identifier such that, if the total number of previous log entries corresponding to the retrieved audience member identifier is an odd number, the processing mechanism sets the enter/exit parameter of the new log entry to “exit” and, if the total number of previous log entries corresponding to the retrieved audience member identifier is even or zero, the processing mechanism sets the enter/exit parameter of the new log entry to “enter”.

Another aspect of the present invention is directed to an apparatus for determining which of one or more audience members are present in a program performance area equipped with reproduction equipment while it is reproducing an audio, visual, or audiovisual program, the apparatus comprising: (a) a self-activating fingerprint reading mechanism equipped to generate a fingerprint data record in response to a detection of a human hand, or portion thereof, held in proximity thereto; (b) a memory device equipped to store one or more fingerprint data records, wherein each of respective fingerprint data records is associated with a corresponding audience member identifier for identifying an audience member; (c) a clock for providing a computer-readable clock output indicative of at least one of present time, real time, and elapsed time; and (d) a processing mechanism programmed to: (i) receive a fingerprint data record from the fingerprint reading mechanism, (ii) compare the received fingerprint data record with one or more stored fingerprint data records stored in the memory device to permit identification of a matching stored fingerprint data record that substantially matches the received fingerprint data record, (iii) retrieve the audience member identifier corresponding to the substantially matching stored fingerprint record from the memory device, (iv) receive the clock output, (v) associate each of respective self-activations of the fingerprint reading mechanism with a new log entry specifying the retrieved audience member identifier, a corresponding enter/exit parameter, and a corresponding clock output, by performing a search of previous log entries created during a predetermined time interval to identify a total number of previous log entries corresponding to the retrieved audience member identifier such that, if the total number of previous log entries corresponding to the audience member identifier is an odd number, the processing mechanism sets the enter/exit parameter of the new log entry to “exit” and, if the total number of previous log entries corresponding to the audience member identifier is even or zero, the processing mechanism sets the enter/exit parameter of the new log entry to “enter”.

Another aspect of the present invention is directed to an apparatus for determining which of one or more audience members are present in a program performance area equipped with reproduction equipment while it is reproducing an audio, visual, or audiovisual program, the apparatus comprising: (a) a self-activating fingerprint reading mechanism equipped to generate a fingerprint data record in response to a detection of a human hand, or portion thereof, held in proximity thereto; (b) a memory device equipped to store one or more fingerprint data records, wherein each of respective fingerprint data records is associated with a corresponding audience member identifier for identifying an audience member; (c) a clock for providing a computer-readable clock output indicative of at least one of present time, real time, and elapsed time; (d) a processing mechanism programmed to: (i) receive a fingerprint data record from the fingerprint reading mechanism, (ii) compare the received fingerprint data record with one or more stored fingerprint data records stored in the memory device to permit identification of any matching stored fingerprint data record that substantially matches the received fingerprint data record, (iii) retrieve the audience member identifier corresponding to any substantially matching stored fingerprint record from the memory device, (iv) receive the clock output, (v) associate each of respective self-activations of the fingerprint reading mechanism with a new log entry specifying the retrieved audience member identifier, a corresponding enter/exit parameter, and a corresponding clock output; and (e) an input mechanism for accepting alphanumeric, numeric, or alphabetic audience member identifiers; wherein, upon activation of the fingerprint reading mechanism, an audience member identifier is entered into the input mechanism before, after, or concurrently with activation of the fingerprint reading mechanism, such that the fingerprint reading mechanism generates a set of fingerprint data, and such that the processing mechanism associates the generated set of fingerprint data with the entered audience member identifier, storing the data and the identifier in memory as a fingerprint record in a fingerprint record table.

Another aspect of the present invention is directed to a method for determining which of one or more audience members are present in a program performance area during an audio, visual, or audiovisual program, the method for use with an apparatus comprising a first self-activating fingerprint reading mechanism, a second self-activating fingerprint reading mechanism, a processing mechanism, a clock, memory, and an output indicator, the memory equipped to store a plurality of respective fingerprint data records each associated with a corresponding audience member identifier for identifying an audience member, the method comprising the steps of: (a) in response to an audience member (i) placing a hand, or portion thereof, in proximity to the first self-activating fingerprint reading mechanism, the first self-activating fingerprint reading mechanism generating a first fingerprint data record; (b) the processing mechanism comparing the generated first fingerprint data record with each of a plurality of stored fingerprint data records accessed from memory to permit identification of a matching stored fingerprint data record that substantially matches the generated first fingerprint data record, so as to permit retrieval of an audience member identifier corresponding to the matching stored fingerprint data record; and (c) the processing mechanism generating an audience log entry that associates the retrieved audience member identifier with a corresponding clock time parameter and a corresponding enter/exit parameter, wherein (i) the processing mechanism loads an input received from the clock as the corresponding clock time parameter, and (ii) the processing mechanism sets the corresponding enter/exit parameter to “enter”; (d) in response to an audience member (i) placing a hand, or portion thereof, in proximity to the second self-activating fingerprint reading mechanism, the second self-activating fingerprint reading mechanism generating a fingerprint data record; (e) the processing mechanism comparing the generated second fingerprint data record with each of a plurality of stored fingerprint data records accessed from memory to permit identification of a matching stored fingerprint data record that substantially matches the generated second fingerprint data record, so as to permit retrieval of an audience member identifier corresponding to the matching stored fingerprint data record; and (f) the processing mechanism generating an audience log entry that associates the retrieved audience member identifier with a corresponding clock time parameter and a corresponding enter/exit parameter, wherein (i) the processing mechanism loads an input received from the clock as the corresponding clock time parameter, and (ii) the processing mechanism sets the corresponding enter/exit parameter to ″ parameter to “exit”.

Another aspect of the present invention is directed to a method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of: (a) in response to an audience member (i) placing a hand, or portion thereof, in proximity to the fingerprint reading mechanism, and (ii) pressing the “enter/exit” button, the fingerprint reading mechanism generating a fingerprint data record; (b) the processing mechanism comparing the generated fingerprint data record with each of a plurality of stored fingerprint data records accessed from memory to permit identification of a matching stored fingerprint data record that substantially matches the generated fingerprint data record, so as to permit retrieval of an audience member identifier corresponding to the matching stored fingerprint data record; and (c) the processing mechanism generating a new log entry that associates the retrieved audience member identifier with a corresponding clock time parameter and a corresponding enter/exit parameter, wherein (i) the processing mechanism loads an input received from the clock as the corresponding clock time parameter, (ii) the processing mechanism performs a search of previous log entries created during a predetermined time interval to identify a total number of previous log entries corresponding to the retrieved audience member identifier such that, if the total number of previous log entries not including the new log entry is an odd number, the processing mechanism sets the enter/exit parameter to “exit” and, if the total number of previous log entries not including the new log entry is even or zero, the processing mechanism sets the enter/exit parameter to “enter”.

Another aspect of the present invention is directed to a method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of: (a) in response to an audience member placing a hand, or portion thereof, in proximity to the fingerprint reading mechanism, the fingerprint reading mechanism generating a fingerprint data record; (b) the processing mechanism comparing the generated fingerprint data record with each of a plurality of stored fingerprint data records accessed from memory to permit identification of a matching stored fingerprint data record that substantially matches the generated fingerprint data record, so as to permit retrieval of an audience member identifier corresponding to the matching stored fingerprint data record; and (c) the processing mechanism generating a new log entry that associates the retrieved audience member identifier with a corresponding clock time parameter and a corresponding enter/exit parameter, wherein (i) the processing mechanism loads an input received from the clock as the corresponding clock time parameter, (ii) the processing mechanism performs a search of previous log entries created during a predetermined time interval to identify a total number of previous log entries corresponding to the retrieved audience member identifier such that, if the total number of previous log entries, not including the new log entry generated at step (c), is an odd number, the processing mechanism sets the enter/exit parameter to “exit” and, if the total number of previous log entries, not including the new log entry generated at step (c), is even or zero, the processing mechanism sets the enter/exit parameter to “enter”.

Another aspect of the present invention is directed to a method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of: (a) in response to an audience member placing a hand, or portion thereof, in proximity to the fingerprint reading mechanism, the fingerprint reading mechanism generating a fingerprint data record; (b) entering an audience member identifier into the input mechanism before, after, or concurrently with step (a); and (c) the processing mechanism associating the generated set of fingerprint data with the entered audience member identifier, storing the data and the identifier in memory as a fingerprint record in a fingerprint record table.

### BRIEF DESCRIPTION OF THE DRAWINGS

In the drawings:

FIG. 1A is a hardware block diagram setting forth a preferred embodiment of the invention.

FIG. 1B is a hardware block diagram setting forth an alternate embodiment of the invention depicted in FIG. 1A.

FIG. 2 is a data structure diagram showing a fingerprint record table for use with the hardware configuration of FIG. 1.

FIG. 3 is a data structure diagram showing an audience log table which includes a number of exemplary log entries.

FIGS. 4A-4C together comprise a flow chart setting forth an operational sequence performed by the hardware configuration of FIG. 1.

### DETAILED DESCRIPTION OF THE PREFERRED EMBODIMENTS

In order to conduct a survey of broadcast program viewing or listening, a survey organization selects test participants based on demographic criteria such as age, income, geographic location, sex, and level of education. Broadcasting organizations and advertisers typically desire a survey which analyzes listener or viewer data in terms of one or more demographic categories. In some cases, individuals who are approached to be survey participants are merely asked to participate in a test, but are not fully informed as to the details of the survey. However, pursuant to the methods and devices of the present invention, each survey participant is told that one requirement of the test is to record all of their entries and exits from a room in which program reproduction equipment is situated. These entries and exits are recorded by the survey participant pressing an “enter” or “exit” button on a stationary device, as appropriate, and placing a hand, or portion thereof, in proximity to a fingerprint reading mechanism on, or associated with, the stationary device.

Additional information is preferably not supplied to survey participants in order to avoid predisposing or prejudicing individual test subjects toward or away from the aims of the survey. For example, if participants were told that the test relates to a survey of radio stations, this might result in more time and attention being paid to radio listening than would be normal for that person. Even worse would be a situation in which survey participants were informed of the identities of one or more specific radio stations commissioning the survey. In order to avoid survey bias, each survey participant is trained in the proper use of the stationary device, but is not provided with unnecessary details regarding the actual purpose of the survey.

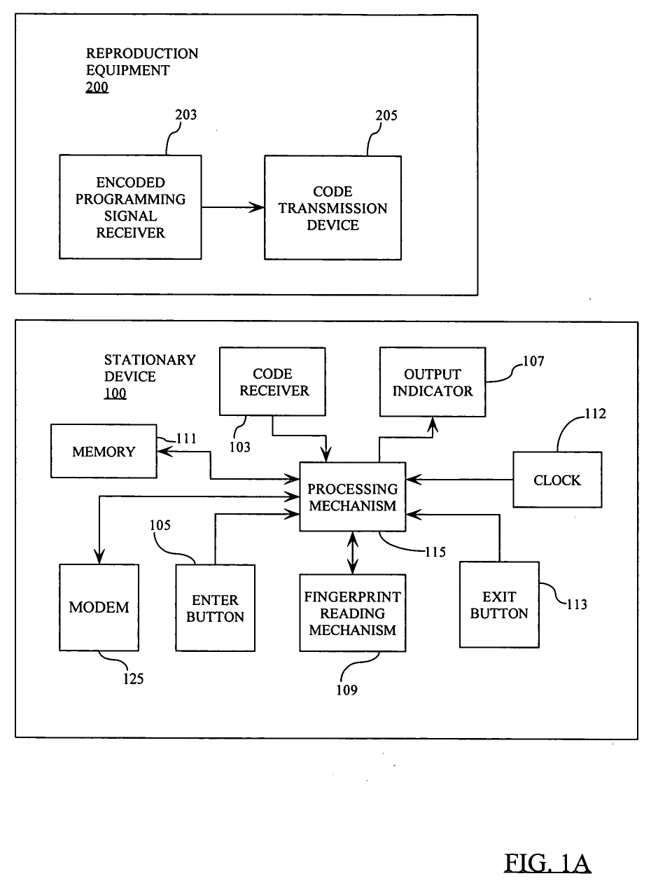

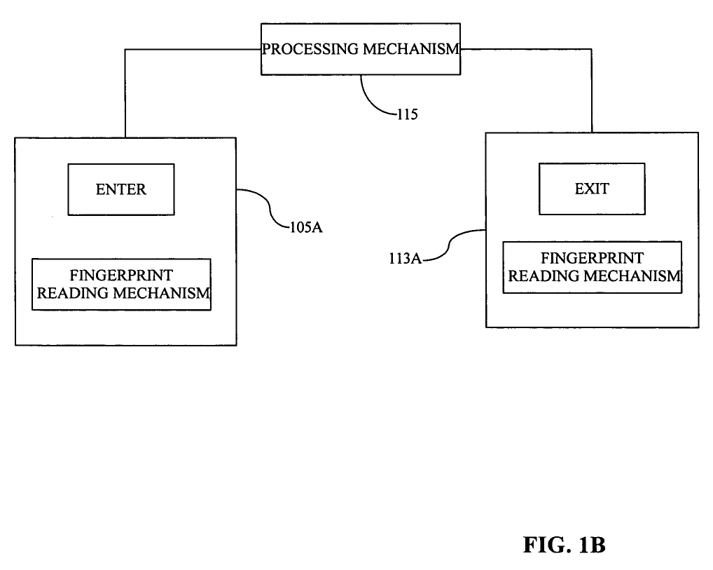

With reference to FIG. 1A, reproduction equipment 200 and stationary device 100 are situated in, or proximate to, a program performance area. This area is typically of sufficient size to accommodate an audience of at least several members. One example of a suitable area is a room with a television set and seating capacity for several persons. Stationary device 100 is equipped to determine which audience members are present in the program performance area during one or more stages of an audio, visual, or audiovisual program presented by reproduction equipment 200.

In practice, stationary device 100 is implemented as a self-contained, relatively small and unobtrusive unit that can be placed on a surface, floor, or support in the room. The installation of stationary device 100 is very simple in that few or no connections to other devices are required. For example, stationary device 100 may be plugged into a wall outlet socket to receive power, and/or furnished with an optional self-contained battery supply. In cases where a battery supply is used, a wall outlet socket connection is optional, but such a connection may be used to recharge the battery supply as needed. To enable a transfer of data between stationary device 100 and a remotely-situated data gathering site, the stationary device 100 is equipped with a modem 125 for communicating over at least one of a telephone line and a wireless communications link. In applications where a wireless communications link is not used, modem 125 of stationary device 100 is connected to a conventional telephone line. Otherwise, a connection to a conventional telephone line is not required.

In view of the foregoing, stationary device 100 may be installed in the homes of consumers in a rapid, straightforward manner which requires no retrofitting of other consumer equipment (such as the consumer's television set, VCR, or DVD player). This is in contrast to prior art surveying devices which require consumer equipment retrofitting for installation. Stationary device 100 improves the level of cooperation by test participants, at least in part because it overcomes potential objections based upon drilling holes into the participant's TV set and modifying circuitry therein.

The embodiment of FIG. 1A is adapted for use in situations where an encoded programming signal uses a surveying code combined with a programming signal. Reproduction equipment 200 includes an encoded programming signal receiver 203 adapted to receive an encoded signal from a signal source such as a TV broadcasting station, a radio broadcasting station, a DVD player, a VCR (video cassette recorder), a CD (compact disc), a computer data storage drive, or the like. The output of encoded programming signal receiver 203, which is a combination of a programming signal and a surveying code, is received by code transmission device 205. Code transmission device 205 is capable of suitably reproducing the programming signal for video and/or audio performance. Alternatively, reproduction equipment 200 may include a separate device, such as a video display screen and/or a sound system, for video and/or audio performance. However, for audience surveying purposes, a key function of code transmission device 205 is to detect the surveying code in the signal received from encoded programming signal receiver 203, and then to transmit the surveying code in a suitable form so as to enable surveying code detection by a code receiver 103 in stationary device 100 (to be described in greater detail hereinafter). Code transmission device 205 may merely retransmit the surveying code as received from the encoded program signal receiver 203 or, alternatively, code transmission device 205 may process the surveying code into another format for reception by stationary device 100.

A discussion of encoded program signals which employ surveying codes can be found in the above-mentioned patents of the present inventor, and such discussion found therein is hereby incorporated by reference. Details of code transmission device 205 can also be found in the above-mentioned patents issued to the present inventor, and such details are also incorporated herein by reference. Suffice it to say that code transmission device 205 is preferably a conventional component of a commercially available video and/or audio instrument, such as a television set. The conventional component of interest could be, for example, the TV's speaker. No retrofitting of the instrument would be required in order for such a component to function as a code retransmission source. In such cases, the output of code transmission device 205 to code receiver 103 of stationary device 100 would be in the form of an acoustical signal. See, for example, U.S. Pat. No. 4,718,106. However, it is also contemplated that some relatively minimal circuitry could be added to process and retransmit the surveying code, as discussed in the above-mentioned patents of the present inventor. For example, refer to U.S. Pat. No. 5,457,807 and U.S. Pat. No. 5,630,203. The invention is also applicable to situations where a surveying code is not employed, whereupon code transmission device 205 and code receiver 103 are optional components, and encoded programming signal receiver 203 may be replaced with a programming signal receiver.

In accordance with a preferred embodiment of the present invention, stationary device 100 is equipped with a fingerprint reading mechanism 109, so as to enable a determination of the identities of audience members who are present in the program performance area during various stages of an audio, visual, or audiovisual program. Stationary device 100 also includes a processing mechanism 115, an “enter” button 105, an “exit” button 113, memory 111, a clock 112, an output indicator 107, a modem 125, and a code receiver 103. Processing mechanism 115 may be implemented by a microprocessor, personal computer, laptop computer, computer mainframe, or personal digital assistant (PDA). Memory 111 may be implemented by read-only memory (ROM), random-access memory (RAM), a data storage drive (such as a hard drive), a CD-ROM drive, an optical drive, a magnetic drive, or by any combination of the aforementioned devices. Modem 125 may be implemented using any communications device equipped for transferring data to and from the public switched telephone network (PSTN) over at least one of a wired and wireless communications link.

“Exit” button 113 and “enter” button 105 may be implemented using any switch or combination of switches that converts proximity, pressure, energy, or motion of one's hand into a change in electrical conductivity. For example, each of these buttons may be provided in the form of a momentary contact pushbutton switch. Separate switches for “exit” button 113 and “enter” button 105 need not be provided, as one multi-position switch, for example, could be used to implement both switches. Clock 112 may be implemented using a real-time clocking mechanism which provides a computer-readable output indicative of real and/or elapsed time. Illustratively, output indicator 107 may include an audio annunciation device that produces a first sound in response to successful retrieval of an audience member identifier, and a second sound in response to failing to retrieve an audience member identifier. Alternatively or additionally, output indicator 107 may include at least one of a first LED (light emitting diode) that illuminates upon successful retrieval of an audience member identifier, and a second LED that illuminates upon failure to retrieve an audience member identifier. Alternatively or additionally, output indicator 107 may include a display screen.

Fingerprint reading mechanism 109 may be implemented using an optical imager, a proximity sensor, or any other type of device that is equipped to acquire a human fingerprint so as to enable the fingerprint to be electronically stored. One suitable optical imager, described by Seigo Igaki in Japanese Patent Laid-Open Gazette No. 61-221883, collates light that is reflected from the human hand to a charge-coupled device (CCD) sensor array. The disclosure of Japanese Patent Laid-Open Gazette No. 61-221883 is incorporated herein by reference in its entirety.

Proximity sensors measure the electrical characteristics of the human hand as a three-dimensional pattern in the surface of the skin. The three-dimensional pattern is stored in an electronic memory device as one or more electrical signals. An example of a suitable proximity sensor for implementing fingerprint reading mechanism 109 is disclosed by Masanori Sumihara in Japanese Patent Laid-Open Gazette No. 5-61965. The disclosure of Japanese Patent Laid-Open Gazette No. 5-61965 is incorporated herein by reference in its entirety. This sensor measures pressure differentials in the three-dimensional pattern of the skin surface of a finger using a piezoelectric thin film. Another suitable proximity sensing device, described by Kazuhiro Itsumi in Japanese Patent Laid-Open Gazette No. 7-168930, uses a pressure-sensitive sheet to measure a resistive or capacitive change caused by contact between the sheet and human skin. The measurement is conducted by observing changes in the electrical signal distribution of a predetermined signal. The disclosure of Japanese Patent Laid-Open Gazette No. 7-168930 is incorporated herein by reference in its entirety.

Fingerprint reading mechanism 109 may, but need not, be implemented using a large-scale integrated circuit (LSI). In a publication entitled “1997 IEEE International Solid-State Circuits Conference”, pp. 200-201 (1997), Marco Tartagni and Robert Guerrieri disclose a capacitive LSI device using a 390 dots-per-inch (dpi) imaging sensor based on a capacitive feedback sensing technique. This article is incorporated herein by reference in its entirety. The LSI detects a three-dimensional pattern from human skin using static capacitive feedback, such that small capacitive detection sensors are arranged in a two-dimensional array. The capacitive detection sensor array includes two plates formed on the uppermost layer of the LSI, and a passivation film formed on the two plates. A skin surface, essentially functioning as a third plate, is isolated by an insulating layer formed from air. Sensing is performed using differentials in skin proximity to the detection sensor. Point-to-point variations in capacitance between the skin and the sensor are detected through the passivation film, thereby detecting the fine three-dimensional pattern of the skin surface of a finger. Another example of a capacitive pressure sensor is described by P. Rey, P. Charvet, M. T. Delaye, and S. Abouhassan in “A High Density Capacitive Pressure Sensor Array For Fingerprint Sensor Applications”, Proceedings of Transducers '97, pp. 1453-1456 (1997). This article is incorporated herein by reference in its entirety.

Yet another device suitable for use as fingerprint reading mechanism 109 is described in U.S. Pat. No. 6,727,800, the entire disclosure of which is incorporated by reference herein. This device is an application specific semiconductor chip, the operation of which is enhanced through the use of standard image processing algorithms. The semiconductor chip includes a fingerprint sensing matrix and a detection signal drive ring. The drive ring accepts a drive signal from an external signal source and applies at least a portion of the drive signal to a human finger. The fingerprint sensing matrix includes a plurality of sensor elements arranged in rows, each element adapted to sense a drive signal received from the finger. Each element in the sensing matrix is provided with an under-pixel amplifier, a synchronous demodulator, and a spatial filter node. Each row in the sensing matrix uses a multiplexer to combine the output of all elements into a single signal. When a finger is placed on the sensing matrix, a very small signal is coupled from the drive ring to the subdermal layer of the skin. This signal follows the ridges and the valleys of the true fingerprint. A fingerprint image is acquired by scanning the sensor elements row by row, and digitizing the outputs from one sensor row at a time, such that power is applied to a selected row, enabling the row to drive an analog channel bus, thereby supplying an output signal to the analog channel bus. The output signal on the analog channel bus is digitized and sent to a processing mechanism which implements a standard image processing algorithm.

The foregoing examples of fingerprint reading mechanisms are illustrative in nature, and are not intended to be limiting in any way. Fingerprint reading mechanism 109 may be implemented using any device that is equipped to convert a human fingerprint into electronically storable data, irrespective of whether such a mechanism operates optically, capacitively, or via an alternate approach. Such knowledge is considered to be within the understanding of any person with ordinary skill in the art.

The above-described surveying codes from reproduction equipment 200, as transmitted by code transmission device 205, are received by code receiver 103 of stationary device 100. Details of such a code receiver 103 are provided in the above-mentioned patents of the present inventor. Such details found therein are incorporated herein by reference. The repetition rate of the surveying code is a matter of design choice depending upon how accurate the survey information needs to be. Each incidence of a detected surveying code is time stamped with the output of clock 112. This arrangement of storing the surveying codes with time stamps enables the association of a program segment (as identifiable from the surveying code) with a list of audience members then in attendance, as will be described in greater detail hereinafter.

As an audience member enters or exits the program performance area, the audience member places a hand or portion thereof, such as a finger or thumb, in proximity to fingerprint reading mechanism 109. If the audience member is entering the area, the member presses “enter” button 105 and, if the audience member is leaving the area, the member presses “exit” button 113. The pressing of “exit” button 113 or “enter” button 105 may take place before, after, or concurrently with placement of the hand or portion thereof in proximity to fingerprint reading mechanism 109. A time-out feature is employed, whereby a timer provides an audience member with a predetermined number of seconds in which his or her fingerprint may be read after the “enter” or “exit” button is pressed. This time-out feature also provides an audience member with a predetermined number of seconds in which to press the “enter” or “exit” button after the fingerprint is read. Fingerprint reading mechanism 109 generates a set of fingerprint data in response to a human hand, or portion thereof, held in proximity thereto. Processing mechanism 115 compares the generated set of fingerprint data with each of a plurality of a pre-stored set of audience member fingerprint data accessed from memory 111 so as to permit retrieval of an audience member identifier corresponding to the generated set of fingerprint data. Processing mechanism 115 activates output indicator 107 in response to at least one of the processing mechanism failing to retrieve an audience member identifier and the processing mechanism successfully retrieving an audience member identifier.

FIG. 1B is a hardware block diagram setting forth an alternate embodiment of the invention depicted in FIG. 1A. It is possible to incorporate the functionality of fingerprint reading mechanism 109 (FIG. 1A) and “enter” button 105 (FIG. 1A) into a combined enter/fingerprint reading mechanism 105A (FIG. 1B), and to incorporate the functionality of fingerprint reading mechanism 109 (FIG. 1A) and “exit” button 113 into a combined exit/fingerprint reading mechanism 113A (FIG. 1B). Enter/fingerprint reading mechanism 105A and exit/fingerprint reading mechanism 113A each include a “self-activation” functionality. When a user enters the program performance area, the user activates enter/fingerprint reading mechanism 105A by pressing on the mechanism 105A and/or holding a hand or a portion thereof in proximity to enter/fingerprint reading mechanism 105A. When the user exits the program performance area, the user activates exit/fingerprint reading mechanism 113A by pressing on the mechanism 113A and/or holding a hand or a portion thereof in proximity to exit/fingerprint reading mechanism 113A. Self-activation of enter/fingerprint reading mechanism 105A and exit/fingerprint reading mechanism 113A obviates the need for “enter” button 105 and “exit” button 113 used in the configuration of FIG. 1A.

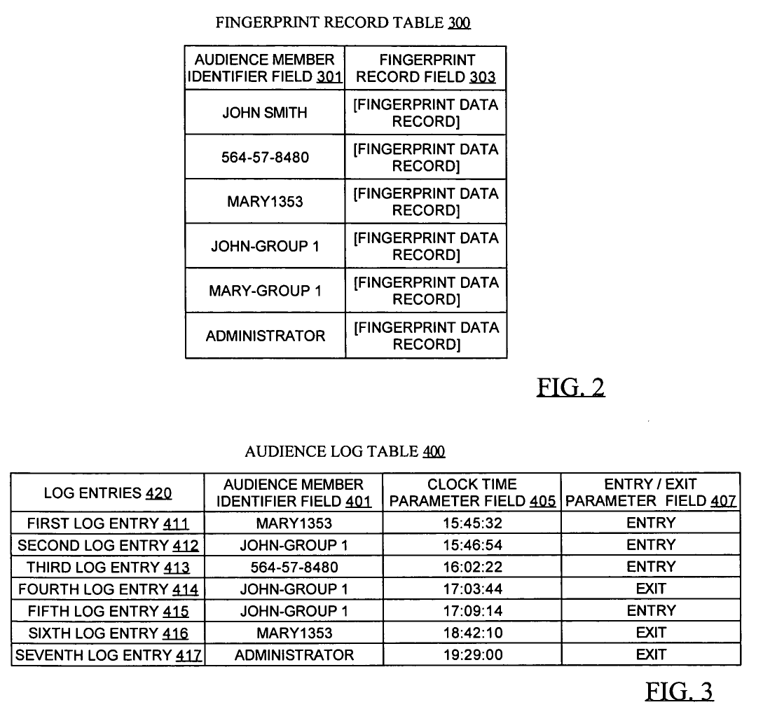

FIG. 2 is a data structure diagram showing a fingerprint record table 300 for use with any of the hardware configurations shown in FIGS. 1A and 1B. The fingerprint record table 300 is a pre-stored set of audience member fingerprint data. Specifically, fingerprint record table 300 associates each of a plurality of respective audience member identifiers pre-stored in an audience member identifier field 301 with a corresponding fingerprint data record stored in fingerprint record field 303. A fingerprint data record stored in fingerprint record field 303 includes fingerprint data unique to an audience member identified by the audience member identifier stored in audience member identifier field 301. Fingerprint data stored in fingerprint record 303 may include data relating to all or a portion of an audience member's right hand, left hand, or both. For example, fingerprint data may include right-hand thumbprints or forefinger prints for each of one or more audience members. As described in greater detail hereinafter, fingerprint data may be generated by stationary device 100 (FIG. 1A) as part of an audience member initiation process or, alternatively, fingerprint data from one or more audience members may be collected by another mechanism and downloaded to memory 111 of stationary device 100.

FIG. 3 is a data structure diagram showing an audience log table 400 which includes a number of exemplary log entries 420, such as first log entry 411, second log entry 412, third log entry 413, fourth log entry 414, fifth log entry 415, sixth log entry 416, and seventh log entry 417. A log entry associates an audience member identifier stored in audience member identifier field 401 with a corresponding clock time parameter stored in clock time parameter field 405 and a corresponding entry/exit parameter stored in entry/exit parameter field 407. For example, first log entry 411 associates audience member identifier “MARY1353” with a clock time parameter “15:45:32” stored in clock time parameter field 405 and an entry/exit parameter of “entry” stored in entry/exit parameter field 407. In response to successfully retrieving an audience member identifier from a generated set of fingerprint data, processing mechanism 115 (FIGS. 1A and 1B) creates a new log entry and stores the log entry in memory 111 (FIG. 1A). Processing mechanism 115 creates the new log entry by loading the retrieved audience member identifier into audience member identifier field 401 (FIG. 3) of the new log entry, and by loading the current value of clock 112 in clock time parameter field 405 of the new log entry. If the audience member pressed “enter” button 105 (FIG. 1A), processing mechanism 115 sets the entry/exit parameter in entry/exit parameter field 407 (FIG. 3) to “enter” and, if the audience member pressed “exit” button 113 (FIG. 1A), processing mechanism 115 sets the entry/exit parameter of entry/exit parameter field 407 (FIG. 3) to “exit”.

Pursuant to an alternate embodiment of the invention, stationary device 100 (FIG. 1A) is equipped with a single “enter/exit” button (not shown) instead of separate “enter” and “exit” buttons 105, 113. In this situation, the log entries of audience log table 400 need not include an enter/exit parameter field 407. As before, in response to successfully retrieving an audience member identifier from a generated set of fingerprint data, processing mechanism 115 creates a new log entry by loading the current value of clock 112 in the clock time parameter field 405 of the new log entry, and by loading the retrieved audience member identifier into audience member identifier filed 401 of the new log entry (FIG. 3). Processing mechanism 115 (FIGS. 1A and 1B) then performs a search of log entries created during a predetermined time interval to identify other log entries wherein the audience member identifier field 401 of the entry specifies the retrieved audience member identifier. The pressing of the single “enter/exit” button may take place before, after, or concurrently with placement of the hand or portion thereof in proximity to fingerprint reading mechanism 109. If the total number of other identified log entries for this audience member (i.e., not including the present entry) is an odd number, processing mechanism 115 (FIGS. 1A and 1B) sets entry/exit parameter in entry/exit parameter field 407 for the new log entry (FIG. 3) to “exit” and, if the number of other identified log entries is even or zero, processing mechanism 115 (FIGS. 1A and 1B) sets entry/exit parameter in entry/exit parameter field 407 (FIG. 3) to “enter”.

It is possible to incorporate the functionality of the single “enter/exit” button into fingerprint reading mechanism 109 to derive a “self-activation” functionality. When fingerprint reading mechanism 109 is activated by a hand or portion thereof held in proximity thereto, this activation replaces the need for the user to press a single “enter/exit” button and, accordingly, the single “enter/exit” button may be eliminated

Pursuant to a further embodiment of the invention, the program performance area is equipped with reproduction equipment 200 (FIG. 1A) that includes an encoded programming signal receiver 203 associated with a code transmission device 205. The encoded programming signal receiver 203 is equipped to respond to a predetermined surveying code embedded in one or more selected portions of an audio, visual, or audiovisual program to be performed. For example, the surveying code may be embedded as an acoustical, subsonic, ultrasonic, subcarrier, or digitally encoded signal to identify at least one of the commencement and ending of a commercial message. Upon receipt of the surveying code, encoded programming signal receiver 203 activates code transmission device 205 to transmit a predefined code to code receiver 103 associated with processing mechanism 115. In response to code receiver 103 receiving the predefined code, processing mechanism 115 retrieves the most recent log entries for each of a plurality of audience member identifiers using audience member identifier field 401 and clock parameter field 405. Processing mechanism 115 uses “entry/exit” parameter field 407 (FIG. 3) to generate at least one of: (a) a list of all audience member identifiers that were present in the performance area upon receipt of the surveying code, or (b) a list of all audience member identifiers that were not present in the performance area upon receipt of the surveying code. Use of this surveying code permits quick and efficient downloading of audience information identifying audience members that are present during a given program segment that may include a commercial advertisement. For instance, assume that audience information is downloaded to a remote data processing center every morning at 3:00 AM. A client wishes to determine audience viewing statistics for a commercial announcement that is broadcast at 8:00 PM. The surveying code permits viewing statistics to be downloaded to the client soon after the commercial is aired at 8:00 PM, with the result that the client need not wait until after 3:00 AM to obtain audience viewing statistics for their commercial.

Pursuant to another embodiment of the invention, processing mechanism 115 (FIGS. 1A and 1B) is coupled to an optional input mechanism for accepting alphanumeric, numeric, or alphabetic audience member identifiers and other pertinent information about such audience member, examples of which are sex, age, address, and so on. Such an optional input mechanism may illustratively include a touch-sensitive display screen, a keyboard, a keypad, a speech recognition system, an array of switches or contacts, or another interface device that, for example, converts mechanical energy into an electrical signal. As an audience member initially enters a program performance area equipped with reproduction equipment 200 for performing a program, the audience member places a hand or portion thereof, such as a finger or thumb, in proximity to fingerprint reading mechanism 109. The audience member uses the interface device to enter his or her audience member identifier into the input mechanism before, after, or concurrently with placement of the hand or portion thereof in proximity to fingerprint reading mechanism 109. Fingerprint reading mechanism 109 generates a fingerprint data record in response to a human hand, or portion thereof, held in proximity thereto. Processing mechanism 115 associates the generated fingerprint data record with the entered audience member identifier, storing the data record and the identifier in memory in fingerprint record table 300 (FIG. 2).

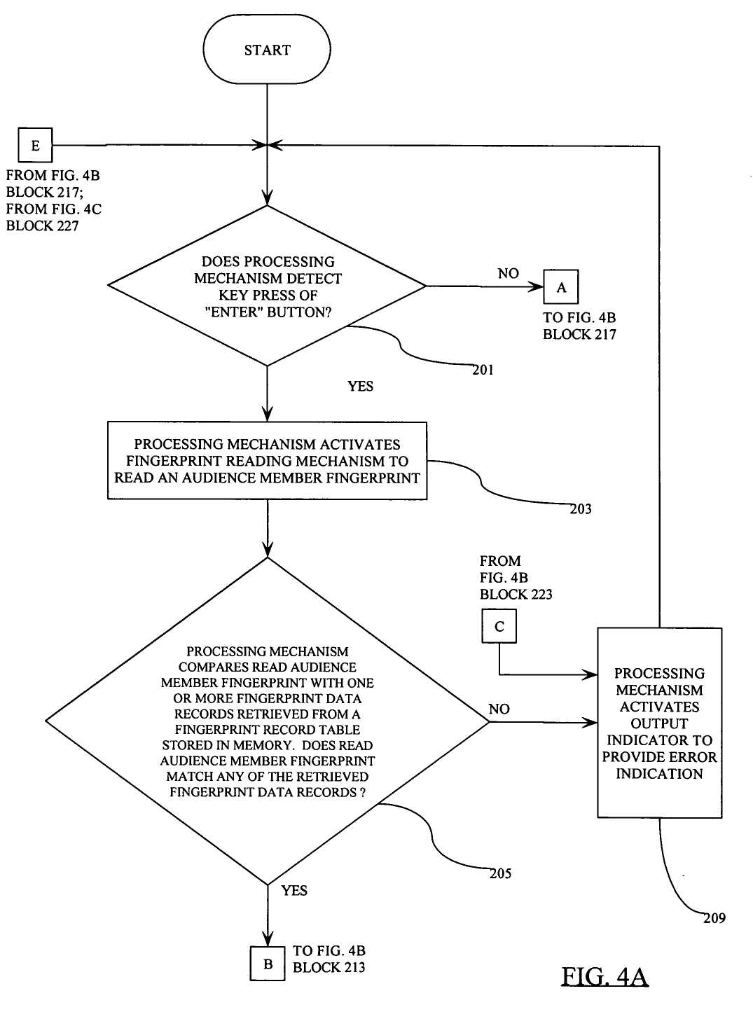

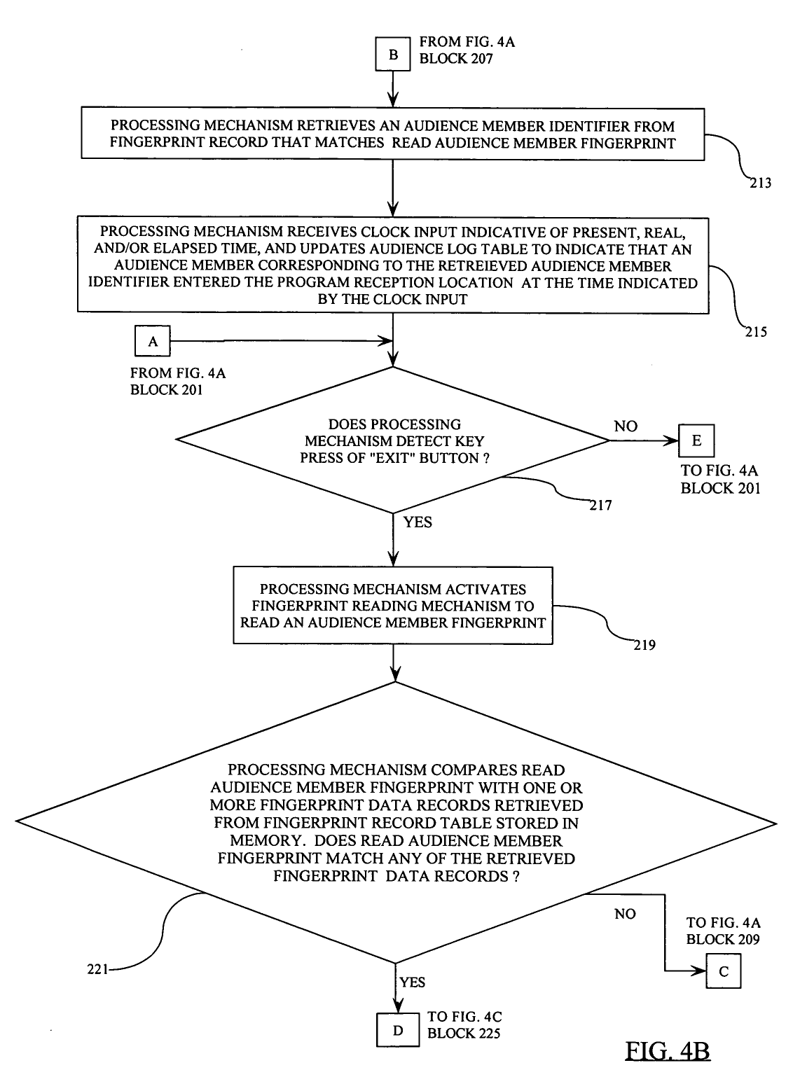

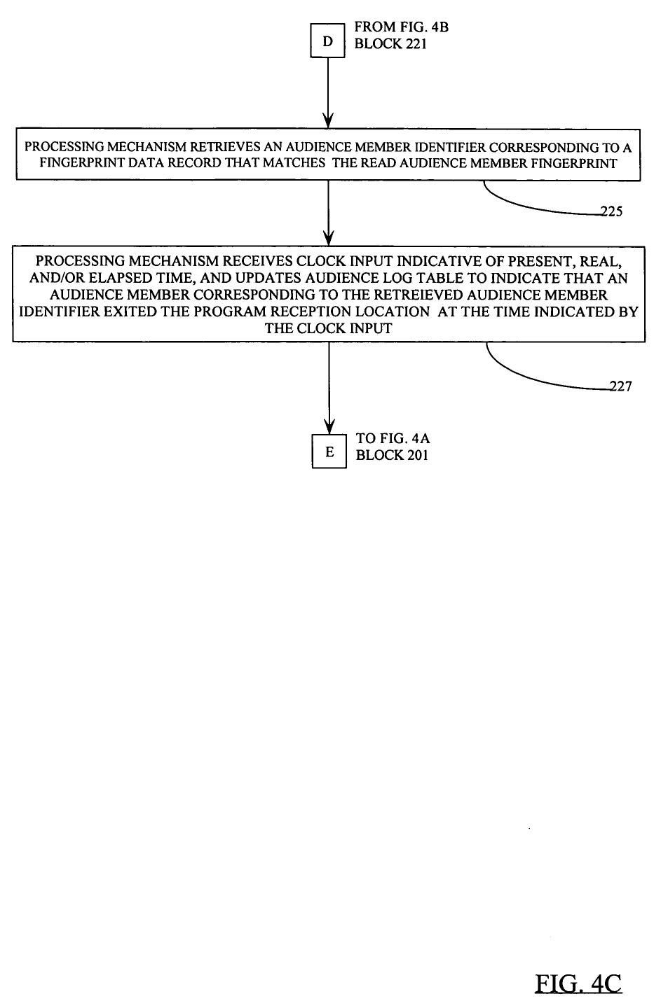

FIGS. 4A-4C together comprise a flow chart setting forth an operational sequence performed by the hardware configuration of FIG. 1A. The operational sequence commences at block 201 (FIG. 4A) where a test is performed to ascertain whether or not processing mechanism 115 (FIG. 1A) detects a key press of “enter” button 105. If not, the program skips ahead to block 217 (FIG. 4B), to be described in greater detail hereinafter. The affirmative branch from block 201 leads to block 203 (FIG. 4A) where the processing mechanism activates fingerprint reading mechanism 109 (FIG. 1A) to read an audience member fingerprint. At block 205 (FIG. 4A), the processing mechanism compares the read audience member fingerprint with one or more fingerprint data records retrieved from a fingerprint record table 300 (FIG. 3) stored in memory 111 (FIG. 1A). A test is performed to ascertain whether or not the read audience member fingerprint matches any of the retrieved fingerprint data records. The negative branch from block 205 leads to block 209 where the processing mechanism activates output indicator 107 (FIG. 1A) to provide an error indication. The program then loops back to block 201 (FIG. 4A).

The affirmative branch from block 205 leads to block 213 (FIG. 4B) where the processing mechanism retrieves an audience member identifier from a fingerprint data record that matches the read audience member fingerprint. The processing mechanism receives input from clock 112 (FIG. 1A) indicative of present, real, and/or elapsed time, and updates the audience log table 400 (FIG. 3) to indicate that an audience member corresponding to the retrieved audience member identifier entered the program reception location at the time indicated by the clock input (FIG. 4B, block 215). A test is then performed at block 217 to ascertain whether or not the processing mechanism detects a key press of “exit” button 113 (FIG. 1A). The negative branch loops back to block 201 (FIG. 4A). The affirmative branch from block 217 (FIG. 4B) leads to block 219 where the processing mechanism activates the fingerprint reading mechanism to read an audience member fingerprint.

At block 221, the processing mechanism compares the read audience member fingerprint with one or more fingerprint data records retrieved from fingerprint record table 300 (FIG. 2). A test is performed to ascertain whether or not the read audience member fingerprint matches any of the retrieved fingerprint data records. If not, the program loops back to block 209 (FIG. 4A). The affirmative branch from block 221 leads to block 225 (FIG. 4C) where the processing mechanism retrieves an audience member identifier from the fingerprint data record that matches the read audience member fingerprint. The processing mechanism receives input from the clock indicative of present, real, and/or elapsed time, and updates the audience log table to indicate that an audience member corresponding to the retrieved audience member identifier exited the program reception location at the time indicated by the clock input. The program then loops back to block 201 (FIG. 4A).

The invention is not limited by the embodiments described above which are presented as examples only but can be modified in various ways within the scope of protection defined by the appended patent claims. Thus, while there have shown and described and pointed out fundamental novel features of the invention as applied to a preferred embodiment thereof, it will be understood that various omissions and substitutions and changes in the form and details of the devices illustrated, and in their operation, may be made by those ordinarily skilled in the art without departing from the spirit of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An apparatus for determining which of one or more audience members are present in a program performance area equipped with reproduction equipment while it is reproducing an audio, visual, or audiovisual program, the apparatus comprising:
(a) a fingerprint reading mechanism equipped to generate a fingerprint data record in response to a human hand, or portion thereof, held in proximity thereto;
(b) a memory device equipped to store one or more fingerprint data records, wherein each of respective fingerprint data records is associated with a corresponding audience member identifier for identifying an audience member;
(c) an input mechanism equipped to accept input from an audience member associated with at least one of the audience member entering the program performance area and the audience member exiting the program performance area;
(d) a clock for providing a computer-readable clock output indicative of at least one of present time and elapsed time; and
(e) a processing mechanism programmed to: (i) receive a fingerprint data record from the fingerprint reading mechanism, (ii) compare the received fingerprint data record with one or more stored fingerprint data records stored in the memory device to permit identification of a stored fingerprint data record that substantially matches the received fingerprint data record, (iii) retrieve the audience member identifier corresponding to the substantially matching stored fingerprint record from the memory device, (iv) detect activation of the input mechanism upon at least one of the audience member entering the program performance area and the audience member exiting the program performance area; (v) receive the clock output, and (vi) generate an audience log entry by associating each of respective activations of the input mechanism with the retrieved audience member identifier, an enter/exit parameter specifying either “enter” or “exit”, and a corresponding clock output.

2. The apparatus of claim 1, wherein the input mechanism comprises an “enter” button and an “exit” button.

3. The apparatus of claim 2, wherein the reproduction equipment includes an encoded programming signal receiver associated with a code transmission device, and the encoded programming signal receiver is equipped to respond to a predetermined surveying code embedded in one or more selected portions of the audio, visual, or audiovisual program.

4. The apparatus of claim 3, wherein the surveying code is embedded in the form of at least one of an acoustical, subsonic, ultrasonic, subcarrier, or digitally encoded signal, so as to identify a reproduction of a commercial message.

5. The apparatus of claim 4, wherein, upon receipt of the surveying code, the encoded programming signal receiver activates the code transmission device to transmit a predefined code to a code receiver associated with the processing mechanism.

6. The apparatus of claim 5, wherein, in response to the code receiver receiving the predefined code, the processing mechanism retrieves one or more previous log entries for a predetermined time period for each of a plurality of audience member identifiers.

7. The apparatus of claim 6, wherein the processing mechanism uses the “enter/exit” parameter to generate at least one of a list of all audience member identifiers that were present in the performance area upon receipt of the surveying code, and a list of all audience member identifiers that were not present in the performance area upon receipt of the surveying code.

8. The apparatus of claim 1, further comprising an output indicator coupled to the processing mechanism, wherein the processing mechanism activates the output indicator in response to at least one of failing to retrieve an audience member identifier and retrieving an audience member identifier.

9. An apparatus for determining which of one or more audience members are present in a program performance area equipped with reproduction equipment while it is reproducing an audio, visual, or audiovisual program, the apparatus comprising:
(a) a first self-activating fingerprint reading mechanism equipped to generate a fingerprint data record in response to a human hand, or portion thereof, held in proximity thereto; wherein activation of the first self-activating fingerprint reading mechanism is associated with an audience member entering the program performance area;
(b) a second self-activating fingerprint reading mechanism equipped to generate a fingerprint data record in response to a human hand, or portion thereof, held in proximity thereto; wherein activation of the second self-activating fingerprint reading mechanism is associated with an audience member exiting the program performance area;
(c) a memory device equipped to store one or more fingerprint data records, wherein each of respective fingerprint data records is associated with a corresponding audience member identifier for identifying an audience member;
(d) a clock for providing a computer-readable clock output indicative of at least one of present time and elapsed time; and
(e) a processing mechanism programmed to: (i) detect activation of the first self-activating fingerprint reading mechanism upon the audience member entering the program performance area; (ii) detect activation of the second self-activating fingerprint reading mechanism upon the audience member exiting the program performance area; (iii) receive a fingerprint data record from at least one of the first self-activating fingerprint reading mechanism or the second self-activating fingerprint reading mechanism, (iv) compare the received fingerprint data record with one or more stored fingerprint data records stored in the memory device to permit identification of a matching stored fingerprint data record that substantially matches the received fingerprint data record, (v) retrieve the audience member identifier corresponding to the substantially matching stored fingerprint record from the memory device, (vi) receive the clock output, (vii) generate a first audience log entry by associating each of respective activations of the first self-activating fingerprint reading mechanism with the retrieved audience member identifier, an enter/exit parameter specifying “enter”, and a corresponding clock output; and (viii) generate a second audience log entry by associating each of respective activations of the second self-activating fingerprint reading mechanism with the retrieved audience member identifier, an enter/exit parameter specifying “exit” and a corresponding clock output.

10. An apparatus for determining which of one or more audience members are present in a program performance area equipped with reproduction equipment while it is reproducing an audio, visual, or audiovisual program, the apparatus comprising:
(a) a fingerprint reading mechanism equipped to generate a fingerprint data record in response to a human hand, or portion thereof, held in proximity thereto;
(b) a memory device equipped to store one or more fingerprint data records, wherein each of respective fingerprint data records is associated with a corresponding audience member identifier for identifying an audience member;
(c) an “enter/exit” button;
(d) a clock for providing a computer-readable clock output indicative of at least one of present time, real time, and elapsed time; and
(e) a processing mechanism programmed to: (i) receive a fingerprint data record from the fingerprint reading mechanism, (ii) compare the received fingerprint data record with one or more stored fingerprint data records stored in the memory device to permit identification of a matching stored fingerprint data record that substantially matches the received fingerprint data record, (iii) retrieve the audience member identifier corresponding to the substantially matching stored fingerprint record from the memory device, (iv) detect a pressing of the “enter/exit” button, (v) receive the clock output, (vi) associate each of respective presses of the “enter/exit” button with a new log entry including the retrieved audience member identifier, an enter/exit parameter, and a corresponding clock output, by performing a search of previous log entries created during a predetermined time interval to identify a total number of previous log entries corresponding to the retrieved audience member identifier such that, if the total number of previous log entries corresponding to the retrieved audience member identifier is an odd number, the processing mechanism sets the enter/exit parameter of the new log entry to “exit” and, if the total number of previous log entries corresponding to the retrieved audience member identifier is even or zero, the processing mechanism sets the enter/exit parameter of the new log entry to “enter”.

11. An apparatus for determining which of one or more audience members are present in a program performance area equipped with reproduction equipment while it is reproducing an audio, visual, or audiovisual program, the apparatus comprising:
(a) a self-activating fingerprint reading mechanism equipped to generate a fingerprint data record in response to a detection of a human hand, or portion thereof, held in proximity thereto;
(b) a memory device equipped to store one or more fingerprint data records, wherein each of respective fingerprint data records is associated with a corresponding audience member identifier for identifying an audience member;
(c) a clock for providing a computer-readable clock output indicative of at least one of present time, real time, and elapsed time; and
(d) a processing mechanism programmed to: (i) receive a fingerprint data record from the fingerprint reading mechanism, (ii) compare the received fingerprint data record with one or more stored fingerprint data records stored in the memory device to permit identification of a matching stored fingerprint data record that substantially matches the received fingerprint data record, (iii) retrieve the audience member identifier corresponding to the substantially matching stored fingerprint record from the memory device, (iv) receive the clock output, (v) associate each of respective self-activations of the fingerprint reading mechanism with a new log entry specifying the retrieved audience member identifier, a corresponding enter/exit parameter, and a corresponding clock output, by performing a search of previous log entries created during a predetermined time interval to identify a total number of previous log entries corresponding to the retrieved audience member identifier such that, if the total number of previous log entries corresponding to the audience member identifier is an odd number, the processing mechanism sets the enter/exit parameter of the new log entry to “exit” and, if the total number of previous log entries corresponding to the audience member identifier is even or zero, the processing mechanism sets the enter/exit parameter of the new log entry to “enter”.

12. An apparatus for determining which of one or more audience members are present in a program performance area equipped with reproduction equipment while it is reproducing an audio, visual, or audiovisual program, the apparatus comprising:
(a) a self-activating fingerprint reading mechanism equipped to generate a fingerprint data record in response to a detection of a human hand, or portion thereof, held in proximity thereto;
(b) a memory device equipped to store one or more fingerprint data records, wherein each of respective fingerprint data records is associated with a corresponding audience member identifier for identifying an audience member;
(c) a clock for providing a computer-readable clock output indicative of at least one of present time, real time, and elapsed time;
(d) a processing mechanism programmed to: (i) receive a fingerprint data record from the fingerprint reading mechanism, (ii) compare the received fingerprint data record with one or more stored fingerprint data records stored in the memory device to permit identification of any matching stored fingerprint data record that substantially matches the received fingerprint data record, (iii) retrieve the audience member identifier corresponding to any substantially matching stored fingerprint record from the memory device, (iv) receive the clock output, (v) associate each of respective self-activations of the fingerprint reading mechanism with a new log entry specifying the retrieved audience member identifier, a corresponding enter/exit parameter, and a corresponding clock output; and
(e) an input mechanism for accepting alphanumeric, numeric, or alphabetic audience member identifiers;
wherein, upon activation of the fingerprint reading mechanism, an audience member identifier is entered into the input mechanism before, after, or concurrently with activation of the fingerprint reading mechanism, such that the fingerprint reading mechanism generates a set of fingerprint data, and such that the processing mechanism associates the generated set of fingerprint data with the entered audience member identifier, storing the data and the identifier in memory as a fingerprint record in a fingerprint record table.

13. A method for determining which of one or more audience members are present in a program performance area during an audio, visual, or audiovisual program, the method for use with an apparatus comprising a first self-activating fingerprint reading mechanism, a second self-activating fingerprint reading mechanism, a processing mechanism, a clock, memory, and an output indicator, the memory equipped to store a plurality of respective fingerprint data records each associated with a corresponding audience member identifier for identifying an audience member, the method comprising the steps of:
(a) in response to an audience member (i) placing a hand, or portion thereof, in proximity to the first self-activating fingerprint reading mechanism, the first self-activating fingerprint reading mechanism generating a first fingerprint data record;
(b) the processing mechanism comparing the generated first fingerprint data record with each of a plurality of stored fingerprint data records accessed from memory to permit identification of a matching stored fingerprint data record that substantially matches the generated first fingerprint data record, so as to permit retrieval of an audience member identifier corresponding to the matching stored fingerprint data record; and
(c) the processing mechanism generating an audience log entry that associates the retrieved audience member identifier with a corresponding clock time parameter and a corresponding enter/exit parameter, wherein (i) the processing mechanism loads an input received from the clock as the corresponding clock time parameter, and (ii) the processing mechanism sets the corresponding enter/exit parameter to “enter”;
(d) in response to an audience member (i) placing a hand, or portion thereof, in proximity to the second self-activating fingerprint reading mechanism, the second self-activating fingerprint reading mechanism generating a fingerprint data record;
(e) the processing mechanism comparing the generated second fingerprint data record with each of a plurality of stored fingerprint data records accessed from memory to permit identification of a matching stored fingerprint data record that substantially matches the generated second fingerprint data record, so as to permit retrieval of an audience member identifier corresponding to the matching stored fingerprint data record; and
(f) the processing mechanism generating an audience log entry that associates the retrieved audience member identifier with a corresponding clock time parameter and a corresponding enter/exit parameter, wherein (i) the processing mechanism loads an input received from the clock as the corresponding clock time parameter, and (ii) the processing mechanism sets the corresponding enter/exit parameter to ″ parameter to “exit”.

14. The method of claim 13, wherein the processing mechanism is coupled to an output indicator, the method further comprising the step of the processing mechanism activating the output indicator in response to at least one of failing to retrieve an audience member identifier and retrieving an audience member identifier.

15. A method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of:
(a) in response to an audience member (i) placing a hand, or portion thereof, in proximity to the fingerprint reading mechanism, and (ii) pressing the “enter/exit” button, the fingerprint reading mechanism generating a fingerprint data record;
(b) the processing mechanism comparing the generated fingerprint data record with each of a plurality of stored fingerprint data records accessed from memory to permit identification of a matching stored fingerprint data record that substantially matches the generated fingerprint data record, so as to permit retrieval of an audience member identifier corresponding to the matching stored fingerprint data record; and
(c) the processing mechanism generating a new log entry that associates the retrieved audience member identifier with a corresponding clock time parameter and a corresponding enter/exit parameter, wherein (i) the processing mechanism loads an input received from the clock as the corresponding clock time parameter, (ii) the processing mechanism performs a search of previous log entries created during a predetermined time interval to identify a total number of previous log entries corresponding to the retrieved audience member identifier such that, if the total number of previous log entries not including the new log entry is an odd number, the processing mechanism sets the enter/exit parameter to “exit” and, if the total number of previous log entries not including the new log entry is even or zero, the processing mechanism sets the enter/exit parameter to “enter”.

16. A method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of:
(a) in response to an audience member placing a hand, or portion thereof, in proximity to the fingerprint reading mechanism, the fingerprint reading mechanism generating a fingerprint data record;
(b) the processing mechanism comparing the generated fingerprint data record with each of a plurality of stored fingerprint data records accessed from memory to permit identification of a matching stored fingerprint data record that substantially matches the generated fingerprint data record, so as to permit retrieval of an audience member identifier corresponding to the matching stored fingerprint data record; and
(c) the processing mechanism generating a new log entry that associates the retrieved audience member identifier with a corresponding clock time parameter and a corresponding enter/exit parameter, wherein (i) the processing mechanism loads an input received from the clock as the corresponding clock time parameter, (ii) the processing mechanism performs a search of previous log entries created during a predetermined time interval to identify a total number of previous log entries corresponding to the retrieved audience member identifier such that, if the total number of previous log entries, not including the new log entry generated at step (c), is an odd number, the processing mechanism sets the enter/exit parameter to “exit” and, if the total number of previous log entries, not including the new log entry generated at step (c), is even or zero, the processing mechanism sets the enter/exit parameter to “enter”.

17. The method of claim 16, further including the step of providing the program performance area with reproduction equipment that includes an encoded programming signal receiver associated with a code transmission device, wherein the encoded programming signal receiver responds to a predetermined surveying code embedded in one or more selected portions of an audio, visual, or audiovisual program to be performed.

18. The method of claim 17, further including the step of embedding the surveying code as at least one of an acoustical, subsonic, ultrasonic, subcarrier, or digitally encoded signal, so as to identify a reproduction of a commercial message

19. The method of claim 18, further including the step of the encoded programming signal receiver activating the code transmission device upon a receipt of the surveying code, so as to transmit a predefined code to a code receiver associated with the processing mechanism.

20. The method of claim 19, further comprising the step of the processing mechanism retrieving one or more previous log entries for a predetermined time period for each of a plurality of audience member identifiers in response to the code receiver receiving the predefined code.

21. The method of claim 20, further comprising the step of the processing mechanism using the “enter/exit” parameter to generate at least one of a list of all audience member identifiers that were present in the performance area upon receipt of the surveying code, and a list of all audience member identifiers that were not present in the performance area upon receipt of the surveying code.

22. A method for determining which of one or more audience members are present in a program performance area during an audio, visual, or audiovisual program, the method for use with an apparatus comprising a fingerprint reading mechanism associated with a processing mechanism, an “enter/exit” button, a clock, memory, and an output indicator, the memory equipped to store a plurality of respective fingerprint data records each associated with a corresponding audience member identifier for identifying an audience member, the method comprising the steps of:
(a) in response to an audience member placing a hand, or portion thereof, in proximity to the fingerprint reading mechanism, the fingerprint reading mechanism generating a fingerprint data record;
(b) entering an audience member identifier into the input mechanism before, after, or concurrently with step (a); and
(c) the processing mechanism associating the generated set of fingerprint data with the entered audience member identifier, storing the data and the identifier in memory as a fingerprint record in a fingerprint record table.
